(19) United States
(12) Patent Application Publication
(10) Pub. No.: US 2004/0021100 A1
(43) Pub. Date: Feb. 5, 2004

(54) Fiber-optic sensor for measuring level of fluid

(76) Inventors: Mikhail Gouzman, Lake Grove, NY (US); Serge Luryi, Old Field, NY (US); Oleg Semyonov, Brooklyn, NY (US)

Correspondence Address: WILLIAM COLLARD, COLLARD & ROE, P.C., 1077 NORTHERN BOULEVARD, ROSLYN, NY, 11576, US

(21) Appl. No.: 10/412,948

(22) Filed: Apr. 14, 2003

Related U.S. Application Data
(60) Provisional application No. 60/372,014, filed on Apr. 12, 2002.

(51) Int. Cl. G01N 15/06; G01N 21/49

(52) U.S. Cl. 250/573

(57) ABSTRACT

A fiber optic sensor for measuring level of fluid consists of an ordered array of multiple optical fibers. Each fiber contains a single sensitive element located on a specific level within the range of fluid level change that transmits different light signals depending on either the sensitive element is immersed in the fluid or located above the level of liquid. The input of the fiber bundle is illuminated by an encoded light beam. A decoding system provides detection of the light patterns at the output and processes it to display the readings. Number of fibers in the bunch determines the number of sensitive sections positioned at different levels and, correspondingly, the accuracy of level measurement.

### BACKGROUND OF THE INVENTION

The present invention relates to level sensors, and more specifically to optical fiber level sensors that generate a measurement based on light damping when a section of fiber sensitive to refractive index of ambient media is immersed in liquid or a portion of light captured by a section of fiber after a fiber rupture (gap) with or without optical elements depends on refractive index of ambient medium. In the context of this invention, the term “liquid” will be used to denote any material capable to be in optical contact with the sensitive section of fiber or with optical elements in the gap (water, fuel, solvents, chemical reagents, inflammable liquids, cryogenic liquids, vines, sodas, alcohol, other technical and food stuffs, etc.) and the term “optical fiber” will be related to any optical light guide of relatively small cross-section with or without cladding and irrespective of material.

Currently, there are numerous types of level sensors on the market. Traditionally, the sensors employing float-based systems are used for fuel storage tanks being the most widely exploited due to their low cost and lasting market position. The capacitance-based sensors are used also, in particular in aviation, offering higher reliability under the conditions of vibrations or shocks, however their relatively higher cost slows their advance in applications such as automotive vehicles, and relatively limited performance in applications for flammable fluids, metal corrosive liquids and solvents, high-purity chemicals, and bio-reagents restricts their utilization in these applications. They are sensitive also to temperature change of the monitored liquid as well as generation of gas bubbles by any reason. The most disadvantaging attribute of these sensors is the presence of electric field and electric contacts in a storage tank containing flammable liquids that threatens always to generate a spark.

In an optical sensor, no electrical contacts or electric fields exist. Optical materials are mostly neutral to chemicals, solvents, flammable liquids, etc. Furthermore, optical sensors have no moving parts capable to introduce hysteresis in measurements. They can be made at relatively low cost due to use of inexpensive, widespread materials like optical fibers or standard optical elements.

Prior art optical level sensors including ones that used optical fibers have suffered from several problems that have limited their functioning reliably in storage tanks of various sizes and in a wide range of liquids. Moreover, prior optical sensors have been made mostly to generate continuous analog signal of light and have generally been suffered from inherent limitations which compromise accuracy and sensitivity because of poor signal-to-noise ratio especially for the lengthy sensors (one foot or more).

U.S. Pat. No. 5,077,482; 5,220,180 and 5,164,608 describe a liquid gauge with an optical fiber disposed within a container, wherein the optical fiber is characterized by an inner fiber core and an outer cladding, the thickness of the cladding being selected to provide significant evanescent light loss when the cladding is immersed in liquid. Light intensity decreasing at the output of the fiber is a function of the portion of fiber immersed in liquid. The sensor generates continuous light signal of low intensity when the tank is full, so that signal-to noise ratio and accuracy of measurements depend on the liquid level for a constant optical noise of the fiber.

Another invention (U.S. Pat. No. 5,743,135) utilizes a transparent float to mark a position of liquid level, the emitting and receiving optical fibers being used to generate a signal when the float reaches the line of sight of the pair of fibers. The sensor is suffered from all the problems of sensors employed float-based systems including hysteresis.

It has been also proposed to use a bundle of optical fibers to transmit the light reflected from a dioptric element subjected to be immersed in liquid; a range of measured levels is determined by a size of this dioptric element.

U.S. Pat. No. 6,173,609 describes an optical sensor that comprises two spaced light guides only one of which can be in contact with the liquid. Several web portions extend along and between the light guides so that some of the light traveling along the first rod is coupled through these web portions into the second light guide. The sensor eliminated the non-linearity of output intensity with liquid level, however it is suffered from the general drawbacks of all analog optical sensors generating continuous light signal: poor signal-to-noise ratio at low intensity signal when the tank is nearly full. Besides, it was proposed (U.S. Pat. No. 3,995,168) to use the bundles of optical fibers with the gaps between the particular aligned bundles of fibers positioned at different levels and optically contacted with the faces of a plastic prism-like structure, so that a light beam emerged from a transmitting bundle was reflected from the base of the prism-like structure and directed into a receiving bundle when the reflecting surface was not in contact with liquid at a given level position of the bundle pair. The sensor provided digital output signal with the accuracy of measurements related to a number of bundle pairs distributed: along a housing of the sensor. However, use of optical fiber bundles limited sensor applications for the small size containers, the bundles needed the protective jackets, because of relatively large diameter of light beam at the vertical reflecting surface of the prism-like structure the intermediate intensity light signals would be detected by the receiving bunch as the liquid level passed the light beam diameter, without optical elements forming the beam in the gap the bundle pairs can not be positioned closer then the size of light beam at the receiving plane of the gap to avoid false readings, no means was foreseen to eliminate the liquid level short-term oscillations, and no encoding of the light beams directed to the bundles was suggested. Besides, any fiber failure to transmit the signal by any reason adds an error to the level reading in the detection scheme employed by the authors.

Thus, there is a need for a sensor that can incorporate the optical fibers to measure levels of liquid being free of the drawbacks of prior art optical sensors.

### SUMMARY OF THE INVENTION

The crux of the present invention lies in the following. A bundle of multiple fibers is disposed through the range of liquid levels with the sensitive to refractive index sections on each fiber distributed at different levels so that each fiber generates only two levels of output signal “yes” or “no”; no analog signal is generated and a digital ratio of yes/no of specifically encoded signals determines the level of liquid. Because of digital nature of the generated signals the optical noise of fibers (microbending, optical impurities or local inhomogeneities of optical fiber's index of refraction) as well as variations of light source intensity doesn't influence the precision of level measurement. Accuracy of level measurements is determined simply by a number of fibers in the bundle, for example a bundle of 1024 fibers provides an accuracy of 0.1% that is independent on the level of liquid. However, selecting the variable spacing between the sensitive sections of the fibers the relative precision of measurements with regard to the residual level of liquid can be kept constant over the range of level positions. No restricting limitations for a length of the sensor or a range of measured liquid levels are introduced. The electric or electronic parts of the sensor can be installed remotely connected to the sensor body in the tank by the fiber optic transmission cables providing 100% guarantee against spark or fire ignition.

### BRIEF DESCRIPTION OF THE DRAWINGS

FIG. 1A is a functional schematic of the sensor 100 according to an embodiment of the present invention comprising a light source 110, a light encoding system 105, a bundle of optical fibers 102, a light decoding system 106 (only if optical decoding is needed), a light detector 104, a system for sensor control as well as for electronic decoding and processing 107 of the detector's signals, and a data presentation system (display gauge and/or a computer with a monitor) 108.

FIG. 1B is an isometric schematic diagram of an optical part of the sensor 100 according to an embodiment of the present invention consisting of a bundle of optical fibers 102 disposed along a holder 101 with the sensitive sections 131 distributed along the holder 101 so that each specific fiber 102-1 contains a sensitive section located at a specific level. The sensor comprises also a feedback fiber 103-1 or a bunch of fibers 103 transmitting the light signals from the fibers 102-1 with the sensitive sections 131 to an output matrix 103-2, an optical feedback element 109 either directly transmitting the light signal to the feedback bundle 103 or performing optical collecting, adding, summation or transformation of the optical signals to direct it to the single feedback fiber 103-1 or backward into the bundle 102, a light source 110 to illuminate the input matrix 102-7 of the fiber bundle 102, a light encoding system 105 and a light decoding system 106, and a light detector 104 to pick up the light emerged from the output matrix of fibers 103-2.

FIG. 1C is a schematic isometric diagram of an input matrix 102-7 of the fiber bundle 102 together with an optical system 111 and the encoding/scanning optical system 105.

FIG. 2 is a side view of the a) U-shaped sensitive sections and b) loops 131-1 formed by bending the fibers without cladding 102-2 of the bundle 102.

FIG. 3 is a side cross-sectional view of the sensitive sections 131: a) formed by removal of a section of cladding (isolation) 102-5 of a fiber 102-3 to open a section of uncovered core 102-4 and b) formed by connecting optically a fiber with cladding 102-3 (bottom part) with a fiber without cladding 102-2 and c) formed by a fiber without cladding 102-2 and a reflective element 121 at the fiber's end, and d) formed by a-fiber with cladding where a section of cladding is removed near its end with the reflective element 121.

FIG. 4 is a side cross-sectional view of the U-shaped sensitive sections 131 of different types formed by: a) a fiber with cladding or isolation 102-3 with a section of cladding or isolation removed, b) a fiber with cladding or isolation 102-3 being in optical contact with a fiber without cladding or isolation 102-2, c) and d) a fiber without cladding or isolation, however with metallic cover or cladding 102-6 at the lower part of U-shape or a loop.

FIG. 5 is a side cross-sectional view of a sensitive section 131 formed by a gap located between two parts of the optical fiber 102-3.

FIG. 6 is a side cross-sectional view of a sensitive section 131 formed by a gap located between two parts of the optical fiber 102-3 with a microlens 141-1 made from a material with the index of refraction lower then the index of refraction of liquid.

FIG. 7 is a side view of a sensitive section 131 formed by a gap located between two parts of the optical fiber 102-3 with a microlens 141-1 made from a material with the index of refraction lower then the index of refraction of liquid and positioned horizontally.

FIG. 8 is a side cross-sectional view of a sensitive section 131 formed by a gap located between two parts of the optical fiber 102-3 with different types of optical elements 141: a) an optional microlens 141-3, b) a microlens formed by the pressed core end 141-4, c) a ball or half-ball lens 141-5, d) a conical end 141-6 of the fiber 102-3, e) a conical lens or a prism 147-7, f) an optional optical system consisting of a condenser lens 141-8 and a correcting lens 142-2. Correcting lenses 142-1 can be installed in all cases to provide optical match of the light beams with the receiving parts of the fiber 102-3.

FIG. 9 is a side cross-sectional view of a sensitive section 131 formed by a gap located between two parts of the optical fiber 102-3 with a prism 141-9: a) the receiving part of the fiber 102-3 is inclined and shifted to pick-up the light beam refracted by the prism 141-9 and b) the receiving part of the fiber 102-3 is installed at another face of the prism to pickup the light beam reflected from the prism's base.

FIG. 10 shows the block diagrams of the detection methods utilized by the sensor: a) the light source 110 is located at the input end of a fiber 102-1 and the receiving part of the fiber after the sensitive element 131 transmits light to the light collector 109 or directly through the feedback fiber 103 to the light detector 104, b) a reflecting and/or a luminescent element are located at the terminated end of the receiving part of the fiber 102-1, so that the light beam of the same wavelength or spectrally transformed light beam is directed back to the fiber 102-1 and the detector 104 peaks-up the light emerged back from the fiber 102-1.

FIG. 11 shows various detection schematics for the method specified in FIG. 10b where a beam splitter 113 is: a) an optical cube or a semitransparent mirror, b) a fiber splitter 114, and c) WDM (wave division multiplexer).

FIG. 12 is a schematic illustration of the end of the fiber part after the sensitive section 131: a) reflective element 121 is located at the end and b) fluorescent 122 and reflective 121 elements are located at the end of the fiber.

FIG. 13 shows schematically the variants of input fiber matrix illumination: a) with a single light source and one-component optical system and b) with a single light source and a multi-component optical system.

FIG. 14 shows two other methods of input matrix illumination: a) with a matrix of light sources and the multi-component optical system and b) with a single source and a beam scanning device.

FIG. 15 is a plane view of two varieties of the light source matrix: a) linear distribution of the light sources (linear matrix) and b) rectangular matrix.

FIG. 16 illustrates graphically the methods of light encoding: a) coding in time domain, b) coding in frequency domain and c) coding in wavelength domain (spectral coding).

FIG. 17 illustrates the decoding methods of the encoded light beam with a single detector at the output of the sensor: a) light beam is encoded in time domain and b) light beam is encoded in frequency domain.

FIG. 18 is the same as FIG. 17 for the spectrally encoded light beam.

FIG. 19 is a schematic of the decoding methods of the multiple output light beams with a matrix (array) of light detectors: a) all detectors are continuously connected in parallel to a multi-channel ADC 117 and b) sequential on-by-one connection of the light detectors to a single ADC.

FIG. 20 illustrates the multiple output beams detection and decoding method with a single light detector and a beam collection device (adder) equipped either with the optical valves or an optical scanning system 109.

FIG. 21 is a schematic diagram of fluid level sensing with a set of sensitive parts on the optical fibers located at different levels in the sensor housing 101 and a multi-component detection system (matrix of the detectors); each light detector of the multi-component detection system generates an electric signal (graph at the bottom) which amplitude depends on the position of a given sensitive section with respect to the level of fluid.

FIG. 22 is a schematic diagram of fluid level sensing with a set of sensitive sections on the optical fibers and a single light detector equipped with the light collecting device 109 or light focusing system 111-3.

### DESCRIPTION OF PREFERRED EMBODIMENTS

In the embodiments to be described below reference will be made to a light source, a light detector and the light encoding and decoding systems. The term light source shall be used to denote a laser, laser diode, LED or any other solid state light source, incandescent or fluorescent lamp, flash lamp, or an optical fiber transmitting light from a remote light source. The term light detector shall be used to denote any device which converts photonic input to electronic output (vacuum tubes, photomultipliers, semiconductor detectors of any type, microchannel plates, CCD, CMOS, etc.). The term encoding system shall be used to denote a device performing time, spatial, frequency, or spectral coding of input light beam and distribution the coded light signals over the fibers in the input fiber array (matrix). The term decoding system shall be used to denote an optical or electronic device performing decoding the output light signals and/or electronic signals generated by the light detector.

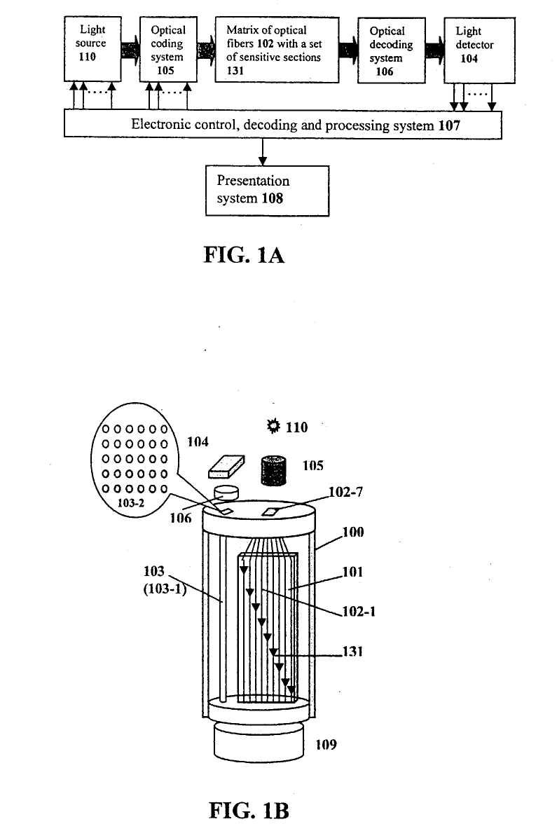

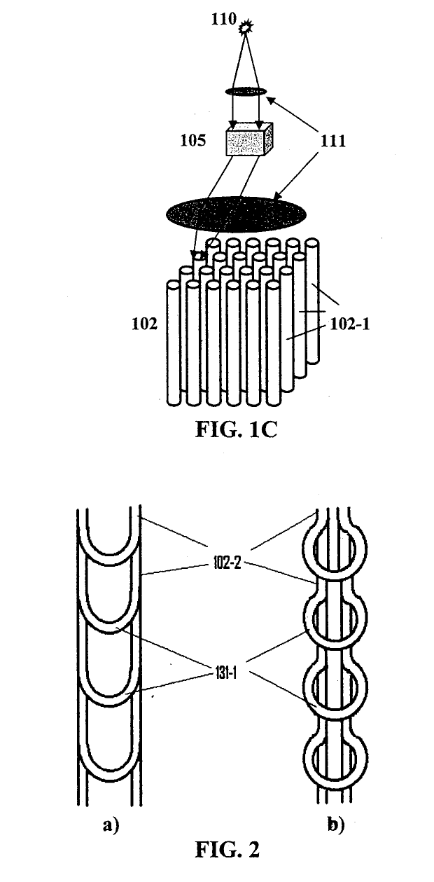

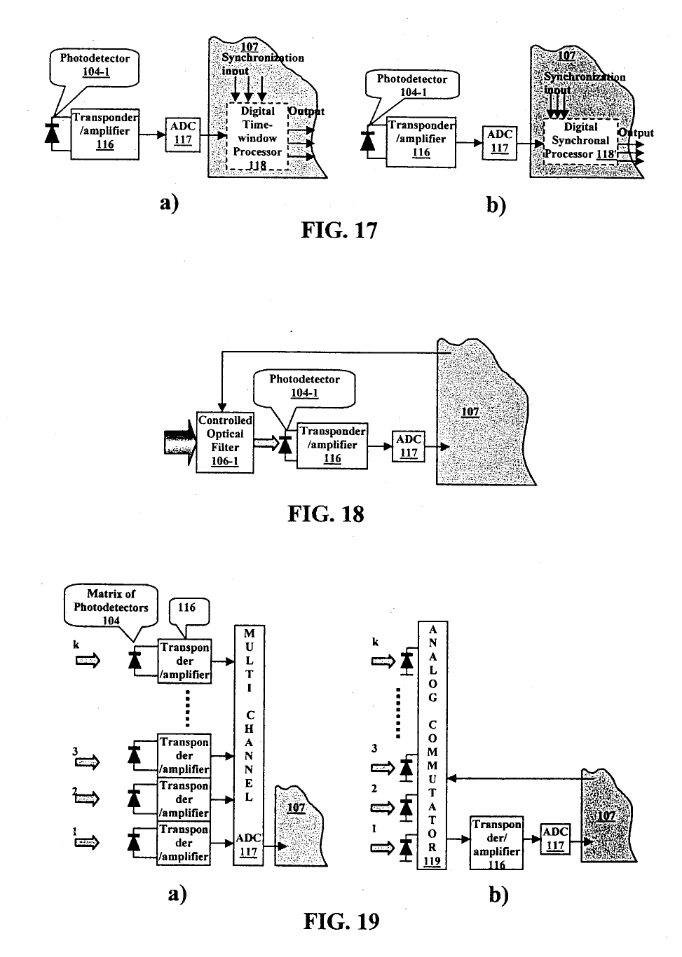

The underlying concept of this invention is in utilization of Snell's low for reflection and/or refraction of light at the interface surface between the probe optical element and liquid or air. The block scheme of the optic fiber level sensor consisting of a light source 110, a light encoding system 105, a bundle of optical fibers 102 with the sensitive sections 131 on each particular fiber, an optical decoding system 106 (if needed), a light detector 104, an electronic control, decoding and processing system 107, and presentation system is shown in FIG. 1A. As seen by FIG. 1B the level sensor is a housing containing a bundle of optical fibers 102 secured on a holder 101, each separate fiber 102-1 being disposed into the housing along the holder 101. The aforesaid optical fibers 102-1 consist of the transmitting and receiving parts with the sections 131 sensitive to index of refraction of the ambient medium, i.e. light transmission through the sensitive sections 131 depends on index of refraction mismatch between the fiber core or an optical element in the section 131 and the ambient medium (air or liquid). The receiving parts of the fibers 102-1 can form a feedback bundle of fibers 103 guiding the light signals to a light detector 104, or they can be optically connected to an optical summer 109 which mixes the light signals transmitted by the receiving parts of the fibers 102-1 and directs the mixed signal into one feedback fiber 103-1 to transmit it to the light detector 104. The receiving parts of the fibers 102-1 can also be connected to the reflective or luminescent elements, so that a light signal of a separate fiber is transmitted back by the same fiber after reflection or spectral transformation; a light splitter must be installed in this case at the input of the fiber bundle 102 to separate the input and output light signals. The sensor is equipped with a light encoding system 105 implementing light beam (or beams) coding. The light beam is emitted by a light source 110. An optical system forms the beam (or beans) and directs it to an input matrix of the fiber bundle 102 as it is more particularly detailed by FIG. 1C. A decoding system 106 is located either at the output of the feedback fiber 103-1 or the bundle 103 as shown at FIG. 1A, if optical decoding is needed, or/and an electronic decoder in a processor 107 executes electronic decoding of the signals generated by the detector 104. The detector 104 passes the signal through a transponder/amplifier 116 and ADC (analog-to-digital converter) 117 to the electronic processor 107 as specified by FIGS. 17-20 that transforms the signal into the form compatible with a presentation system 108 to display the reading.

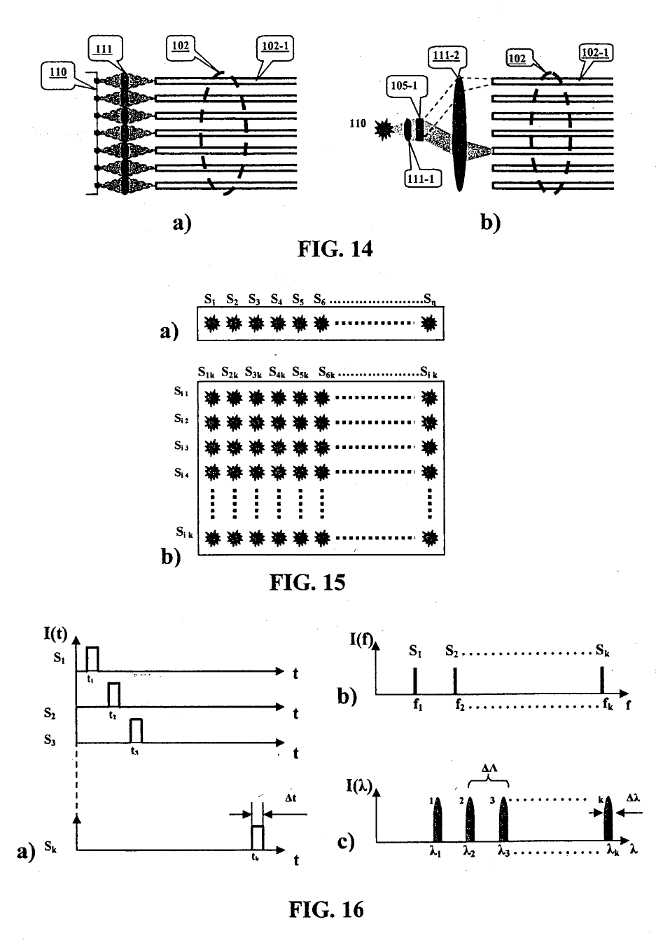

As seen by FIG. 1C, FIG. 13 and FIG. 14 the optical system 111 forms the light beam to illuminate the input matrix 102-7 as a whole or a separate fiber 102-1 of the input matrix 102-7 and an optical encoding system implements beam coding, i.e. time, high frequency, spectral, or other possible light beam encoding, and/or beam scanning over the input matrix to illuminate a specific fiber at a certain moment.

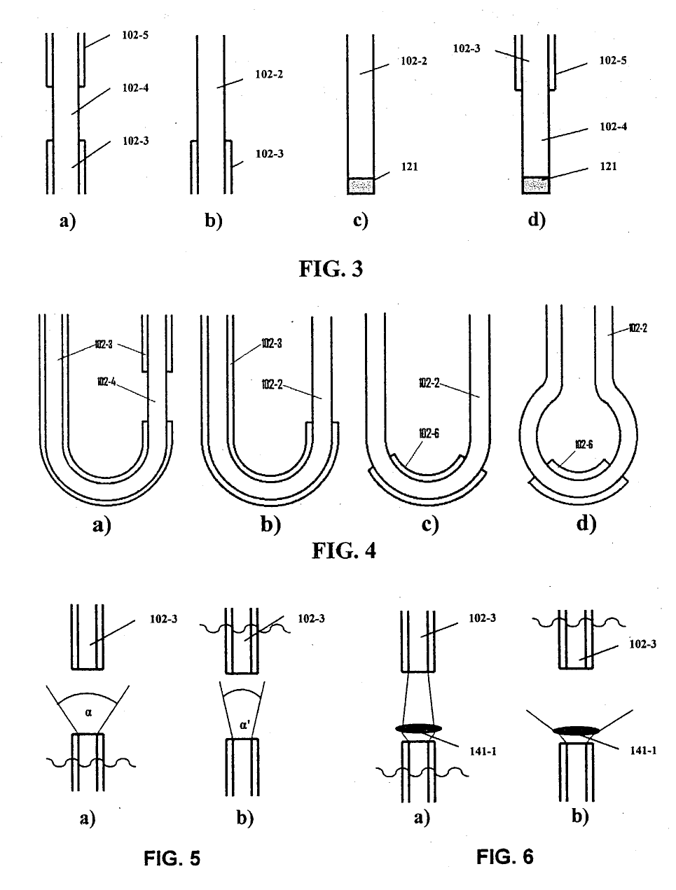

Different types of sensitive elements 131 formed on the fiber without cladding 102-2 or with cladding 102-3 are shown in FIG. 2, FIG. 3 and FIG. 4.

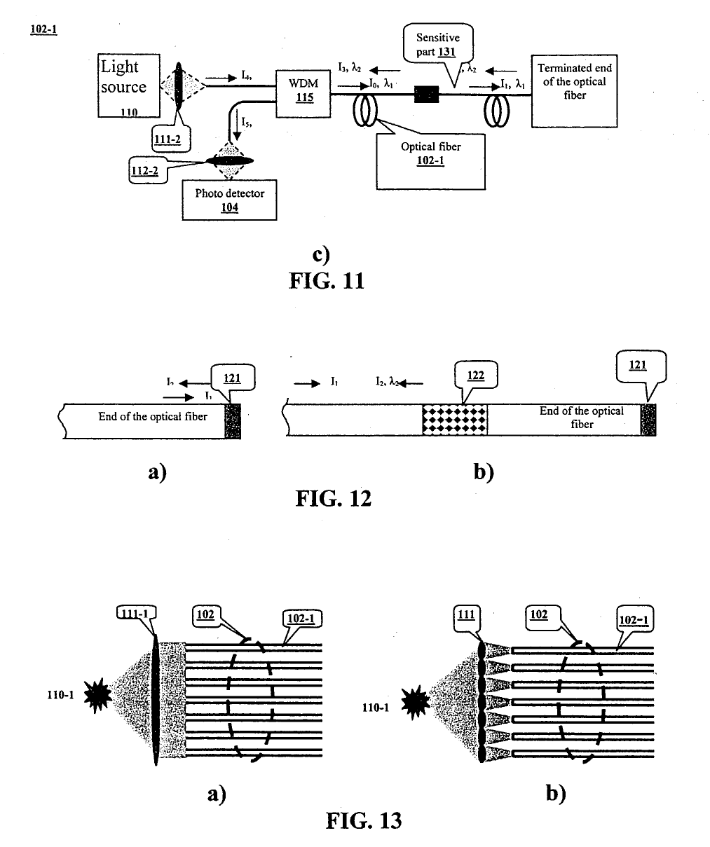

According to the Snell's law a light ray launched from the light source contains inside the multimode fiber if an angle of its propagation in the fiber doesn't exceed the critical angle θ_{c} of total internal reflection at the boundary between the fiber surface and a cladding or an ambient medium:

$${θ}_{c} = {cos}^{- 1} ( \frac{{n}_{2}}{{n}_{1}} ) = arcos \frac{{n}_{2}}{{n}_{1}} ,$$

where n₁ is an index of refraction of fiber (core) material and n₂ is an index of refraction of cladding or ambient medium. Light guiding property of a section of the fiber core capable to be in contact either with fluid or with air depends on the refractive index of the ambient medium. If the total number of modes propagating in the multimode fiber N>>1 and all modes are excited the light power transmitted by the fiber without cladding will drop as (θ_{cliq}/θ_{cair})²˜(n₁²-n_{liq}²)/(₁²-1) when a part of it is immersed from air into liquid, where n_{liq} is the refractive index of liquid, θ_{cliq} is the critical angle for the part of fiber without cladding immersed in liquid, θ_{cair} is the critical angle of the fiber in air, (n₁²-n_{liq}²) is the numerical aperture of the fiber or a section without cladding immersed in liquid, and (n₁²-1) is the numerical aperture of the fiber or the section without cladding located in air. Correspondingly, if the sensitive section is formed on the fiber with cladding by removing a section of cladding the light power transmitted trough this section will drop as (n₁²-n_{liq}²)/(n₁²-n₂²), where n₂ is the refractive index of cladding, providing n₂<n_{liq}. As seen by FIG. 2 the fibers without cladding 102-2 disposed from the top of the holder 101 can be bended to form the U-sections or loops 131-1 distributed across the range of fluid levels. The particular fiber transmits light from the input end (matrix) to its output freely being located completely above the level of liquid, however the transmission decreases dramatically if the level of liquid reaches the corresponding U-section or loop or rises higher provided that the refractive index of liquid is relatively well matched to that of the fiber. Another solution is to dispose the fibers of different length without cladding equipped with the reflective elements (mirrors) at its end 121 as shown in FIG. 3d into the tank, so that the same fiber transmits the reflected light back to the input end of the fiber 102-2 where a splitter 113, 114 or 115 as specified by FIG. 11 directs the reflected beam to the detector. With the next reference to FIG. 4C and D the bottom part of the U-sections or loops are covered by a metallic layer or a layer of other isolation material 102-6 with the refractive index nₛ<n_{liq}≦n₁ to exclude influence of a liquid drop that can accumulate at the bottom part of the loop on the light transmission when the loop is in air and to avoid the false reading. The size of the loop or U-section should be sufficient to provide good light transmission through the bended parts as well as to prevent possible liquid drop accumulation over the total loop covering the sensitive parts of the fiber 102-2 because of surface tension. The length of the isolating layer 102-6 should also exceed the size of a drop that can form at the bottom parts of U-sections or loops.

As seen also by FIG. 3 the sensitive elements 131 on the fiber with cladding 102-3 may be formed by: a) removing a section of cladding 102-5 at a certain distance from the input end of the fiber 102-3 uncovering the fiber's core 102-4 and making possible for the core to be in contact with ambient medium (air or liquid) as shown in FIG. 3a; b) making optical contact of the fiber with cladding 102-3 disposed from the tank bottom with the fiber without cladding 102-2 disposed from the top at a certain level of the range of liquid levels (FIG. 3b); and c) removing a section of cladding near the end of the fiber 102-3 equipped with the reflective or fluorescent element at its end (FIG. 3d and FIG. 12). The fibers 102-3 either may be disposed strait along the total length of the holder 101 with the sensitive elements 131 positioned at different levels (FIG. 3a and b, FIG. 21 and FIG. 22) and the light detector can be installed elsewhere including the end of the holder 101 opposite to the light input end either they are bended to form the U-loops directing the light beam back to the input end of the holder 101 (FIG. 4a and b); in another design (FIG. 3d) the sections of the fibers 102-3 equipped with the reflective or fluorescent elements are disposed at the different distances along the holder 101 and the light reflected or transformed at their ends is directed back into the same section of the fiber 102-3. It should be noted that the position of the input end of the holder 101 with the light source 104 could be either at the tank's bottom or top equivalently for the designs shown in FIG. 3a,b and d as well as in FIG. 4a.

The sensitive elements 131 formed by making a gap between two sections of the fiber with cladding 102-3 with or without the additional optical elements are shown schematically in FIG. 5 to FIG. 9. As seen by FIG. 5 the sensitive element can be a simple gap between two sections of the fiber 102-3; the light rays emerged from the fiber section output are formed a cone with an apex angle:

$${θ}^{′} = 2 {sin}^{- 1} ( \frac{{n}_{1}}{{n}_{am}} sin {θ}_{c} ) ,$$

where nₐₘ is the refractive index of the ambient medium. The apex angle of the light cone is narrower when the gap is immersed in liquid because n_{liq}>1 and a fraction of light power captured by the opposite (receiving) section of the fiber increases by the factor of (θ′ₐᵢᵣ/θ′_{liq})², where θ′ₐᵢᵣ is the apex angle of output light cone of the fiber in air and θ′_{liq} is the apex angle of output light cone of the fiber in liquid, if the liquid is transparent.

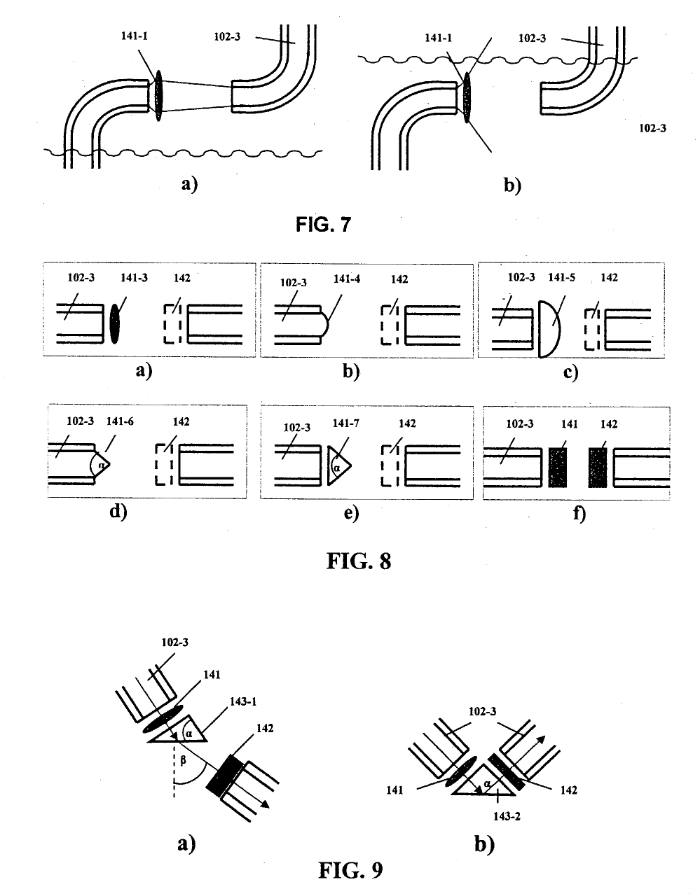

Turning next to FIG. 6 a microlens made of the material with the refractive index n<n_{liq} is placed in the gap which focuses the light beam emerged from transmitting section of the fiber 102-3 to the facet of the receiving section of the fiber when the gap is in air and defocuses the beam when the gap is immersed in liquid. In this case, the fraction of light power captured by the receiving part of the fiber will be decreased dramatically when the gap is submersing from air into liquid. As seen by FIG. 7 the gap with or without optical system can be positioned horizontally to eliminate an uncertainty of level measurement related to the gap length.

In general, an optional optical system made of one or two components in the gap between the transmitting and receiving sections of the fiber 102-3 as seen by FIG. 8 may be adjusted to focus the light beam onto the facet of the receiving section of the fiber in one medium, so that the numerical aperture of the optical system matches approximately to that of receiving fiber; being transferred to another medium the optical system becomes out of focus and the light power captured by the receiving section of the fiber decreases due to numerical aperture mismatch. An optional two-component optical system comprising a focusing lens 141-8 and adjusting lens 142-2 is shown schematically in FIG. 8f and different types of the first focusing microlens are: a conventional focusing lens 141-3 (FIG. 8a), a lens formed by core facet hot-pressed a bit out of cladding 141-4 (FIG. 8b), a ball or semi-ball microlens 141-5 (FIG. 8c), a cone lens or a prism ether connected optically to the transmitting section of fiber 141-7 (FIG. 8e) or formed by the fiber end processed properly 141-6 (FIG. 8d). In the last case the apex angle a of the cone or prism can be chosen properly to provide total reflection of light transmitted by the fiber from the side faces when the gap is in air, allowing however light propagation to the receiving fiber when it is immersed in liquid:

$$2 ( {cos}^{- 1} \frac{{n}_{liq}}{{n}_{p}} - {θ}_{c} ) \leq α \leq 2 ( {cos}^{- 1} {n}_{p}^{- 1} - {θ}_{c} ) ,$$

where nₚ is the refractive index of the cone or prism material. Being immersed in liquid and providing nₚ>n_{liq} the cone lens focuses light to the receiving part of the fiber. If, conversely, nₚ<n_{liq} the lens becomes defocusing and its apex angle α has to be kept above 2 (cos⁻¹nₚ⁻¹+θ_{c}) providing transparency and focusing in air. Alternatively, the cone can be used as a sensitive reflective element to direct the light beam back into the fiber and then to detector installed after the splitter at the light input end when the cone is in air and to transmit light through when it is in liquid.

With reference now to FIG. 9 the refracting or reflecting prism can be added into the gap. As seen by FIG. 9a the angle of refraction of the right-angled prism

$$β = {sin}^{- 1} ( \frac{{n}_{p}}{{n}_{am}} cos α )$$

is different for different ambient media, so that the light beam is inclined out of receiving fiber when the gap is transferred from air to liquid or vice versa depending on which medium was chosen for the perfect match. On the other hand, the angle α of the right-angled prism can be chosen properly to provide total internal reflection from the prism's base when it is in air, however allowing light propagation into the liquid when it is immersed:

$${cos}^{- 1} \frac{{n}_{lip}}{{n}_{p}} < α < {cos}^{- 1} {n}_{p}^{- 1} .$$

Alternatively, as seen by FIG. 9b the prism with total reflection from its base in air can be coupled with an optional optical system to direct the reflected light into the receiving part of the fiber and in addition to the prior art sensors with the reflection prisms or its analogs the optical system provides light beam matching to the numerical aperture of the receiving fiber.

Every sensitive section on a particular optical fiber 102-1 is positioned at a certain level in the range of liquid levels as seen by FIG. 21, so that either they form an equidistant set of the sensitive section along the holder 101 to provide an accuracy of measurements referred to total range of liquid levels L or they are distributed non-uniformly along the holder 101 to keep the accuracy related to the residual liquid level constant. In the first case the accuracy of level measurements is d/L=1/N, where d is a distance between two nearest sensitive section and n is a number of fibers 102-1 in the bundle 102, and a relative error of measurements ε=d/L′ where L′ is a current level of liquid increases with the decreasing level. To keep the relative error constant the sensitive sections formed on different fibers 102-1 has to be distributed as d′=εₒL′, where εₒ is a chosen accuracy of measurements and d′ is a distance between the nearest sensitive sections just below the current liquid level L′, excluding the lowest portions of the holder 101 where further d′ decreasing is limited either by the sensitive sector size, or fiber diameter or optical system size. Yet another option is to realize a stepwise distribution of the sensitive sections, for example to arrange them 10 times more frequently on the lower part of the holder equal to 0.1 L.

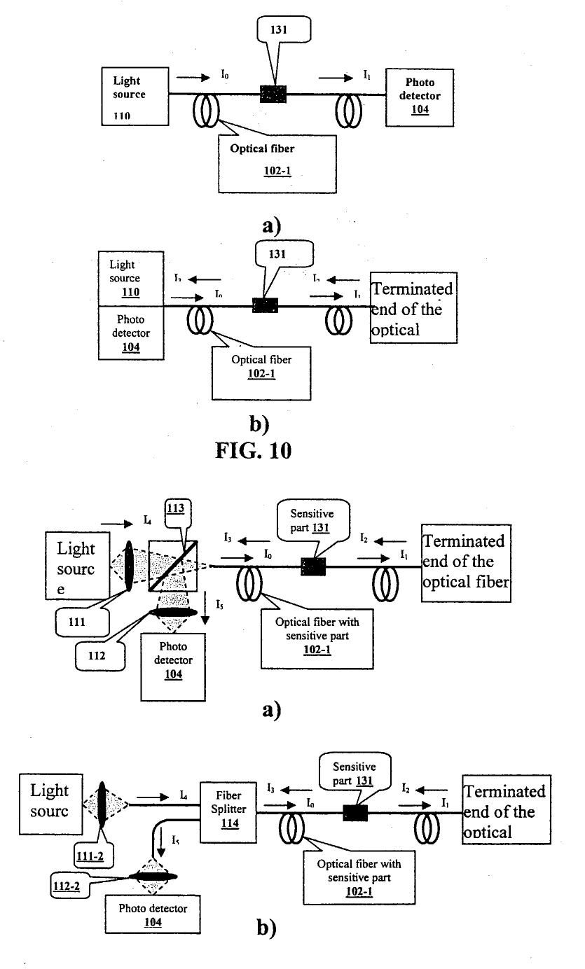

Next with reference now to FIG. 10 the particular layout of the light detecting part of the sensor is related to two basic methods of light beam transmission to the detector 104. As seen by FIG. 10a the output end of the fiber bundle 102 can be connected either directly to the detector (or optical decoder) or through the light collector (adder) that optically process the light signals and directs the encoded light signal to the feedback fiber 103-1 as specified by FIG. 1B and FIG. 22. The light detector can be located anywhere: at the opposite end of the holder 101, at the input end of the holder 101 however separately from the illumination system as shown in FIG. 1B, or remotely with a fiber transmission line connected to the sensor optical output. Another option as particularly detailed by FIG. 12 is to connect each fiber to the reflective element 121 either immediately after the sensitive section (FIG. 3c and d) or at the end of the fiber 102-1 which is opposite to the input matrix 102-7 (FIG. 12a) in particular at the output end of the holder 101 where the fibers can be connected to a common reflective mirror or a fluorescent element in the housing 109 as seen by FIG. 1B. Besides, a photoluminescent element 122 can be installed at the end of each fiber 102-1 either separately or in combination with the reflective element 121 as particularly detailed by FIG. 12b to transform a fraction the incoming light to another wavelength for detection. In all these cases the reflective element directs the light beam back into the fiber 102-1 and the reflected signal has to be separated from the incident light at the input to the matrix 102-7. The light beam splitting methods are shown schematically in FIG. 11. An optical cube or semitransparent mirror can be installed between the light source 104 (encoding optical system 105) and input matrix 1027 to separate incident light from the light signal transmitted back either by a particular fiber as shown in FIG. 11a or by the whole matrix. As seen by FIG. 11b a fiber splitter connected to each fiber of the input matrix will separate the reflected signals effectively and the corresponding output fibers 103-3 after the splitter can be assembled in the output matrix 103-2. A wave division multiplexer (WDM) installed at the input matrix is another option to separate the light beams and to assemble, the output fibers in the matrix when the light signals for detection propagate the same fibers 102-1 towards the incoming light.

Several options of input fiber matrix 102-7 illumination are possible as seen by FIG. 13 and FIG. 14. Shown schematically in FIG. 13a is a method of simultaneous illumination of the whole matrix 102-7 by a continuous or pulsed light source 110-1 through an optical system 111-1 resulting in distribution of light patterns at the output fiber matrix 103-2 for a certain fluid level in the tank as seen by the callout in FIG. 1B. Another option is to use a multi-lens optical system 111 to split the light emitted by the source 110-1 into separate beams and to direct them into separate fibers 102-1 of the matrix 102 as seen by FIG. 13b. The fibers 102-1 assembled in the matrix 102-7 can be illuminated also by the multiple light sources Sᵢₖ either assembled in line or in two-dimensional matrix as particularly detailed by FIG. 15a and b; each separate fiber can be optically connected directly to the corresponding light source Sᵢₖ or light from each source is collected by the optical system and directed into the corresponding fiber 102-1 of fiber matrix 102-7 (FIG. 14a) provided that the numerical aperture of the optical system matches that of the fiber 102-1. The two-dimensional matrix of light sources 110 and the corresponding input matrix of fibers 102-7 can be formed from the linear distribution of subsequent channels either by bending the line and creating the zigzag distribution or cutting the line and shifting the sections one below another to form the raster distribution. Other matrix forms are also feasible, for example a spiral matrix or a matrix with radial/angular distribution of elements (light sources and fibers). The same is related to the output fiber matrix 103-2. A beam scanning system 105-1 coupled with the optical system 111 and, if necessary, with frequency or spectral encoding system can be used to scan a light beam from a single light source 110-1 over the input matrix of fibers 102-7 as shown in FIG. 14b.

Several light encoding methods can be implemented in the fluid level sensor. Coding in time domain is achieved by generating light pulses Δt delayed relatively each other by an interval T (Δt<T) and distributed over the fibers 102-1 of the input matrix 102-7 ether consequently as seen by FIG. 16a or in any other succession. A series of light pulses are generated by: a) the matrix of light sources (FIG. 15) where the on and off states of a particular light source are controlled electronically by the control system 107, b) the electro-optical encoding system 105 (matrix of electro-optical elements 105-1) installed between the continuous source 110 (matrix of continuous sources 110-1) and controlled by the electronic control system 107, and c) the scanning system 105-1 (FIG. 14b) which scans the light beam emitted by a single continuous light source over the input matrix so that the pulse width in a particular fiber 102-1 Δt=d/vₛ and the time interval between the pulses T=ΔL/vₛ, where d is fiber diameter, vₛ is scan speed in the plane of input matrix 102-7 and ΔL is fiber-to-fiber distance. The scanning system can be coupled also with the encoding system of any type synchronized with the scans.

Coding in frequency domain is achieved by modulating the light intensity with the radio frequency so that the light beam propagating in i-th particular fiber 102-1 is modulated with a particular frequency fᵢ (FIG. 16b). Light modulation can be implemented by: a) controlling emission of the light sources Sᵢₖ in the light source matrix (FIG. 15) so that the light intensity of a particular light source is modulated with a particular frequency, b) modulating the light intensity generated by a continuous light source with the electro-optical encoding system 105 comprising a matrix of encoding elements to encode the beams generated by the matrix of sources (each element for a particular source), and c) modulating the light pulses either generated by the pulsed light sources or produced in the scanning version of time encoding system (FIG. 14b) with a single encoding system (common for all beams if a matrix of light sources is used), so that frequency of modulation changes stepwise with the every period between the pulses resulting in particular modulation frequency for a particular pulse in a series of light pulses. Coding in wavelength domain or spectral coding is achieved by dispersion of light emitted from the light source (sources) and distribution the spectrum obtained over the input matrix (line) of fibers 102-7 as particularly detailed by FIG. 16c, so that Δλ<ΔΛ, where Δλ=d·D is the spectral width of a particular beam with the characteristic wavelength λᵢ inserted in i-th fiber 102-1, ΔΛ=λᵢ₊₁−λᵢ=ΔL·D is the spectral interval between the consecutive fibers, and D is the spectral dispersion in the plane of the input matrix 102-7. It can be implemented either by a light dispersing element placed between the single light source 110-1 and the input fiber matrix 102-7 or by a distributed spectrum filter placed in front of the input fiber matrix (line) in the multibeam optical system (FIG. 14a) or the scanning system (FIG. 14b).

The methods of light detection and light beam decoding at the output of the fiber 103-1 or the fiber matrix 103-2 are shown schematically in FIGS. 17-22. Referring to FIG. 17a the light signals encoded in time domain are received by the single light detector 104-1 which transforms them in current or voltage signals; the electronic signals are transmitted through a transponder/amplifier 116 and an analog-to-digital converter (ADC) 117 to a synchronized time-window processor 118 for decoding and subsequent processing by the electronic processor 107. With reference now to FIG. 17b the light signals modulated in frequency domain are detected by the single light detector 104-1 which transforms them in current/voltage signals; the electronic signals are transmitted through the transponder/amplifier 116 and ADC 117 to a digital synchronal processor 118′ for decoding and subsequent processing by the electronic processor 107. Turning next to FIG. 18 the spectrally encoded light beams are decoded by a digitally controlled optical filter 106-1 and the single light detector 104-1 placed after the filter 106-1 converts the light signals in the electronic signals that are transmitted again through the transponder/amplifier 116 and ADC 117 to the processor 107.

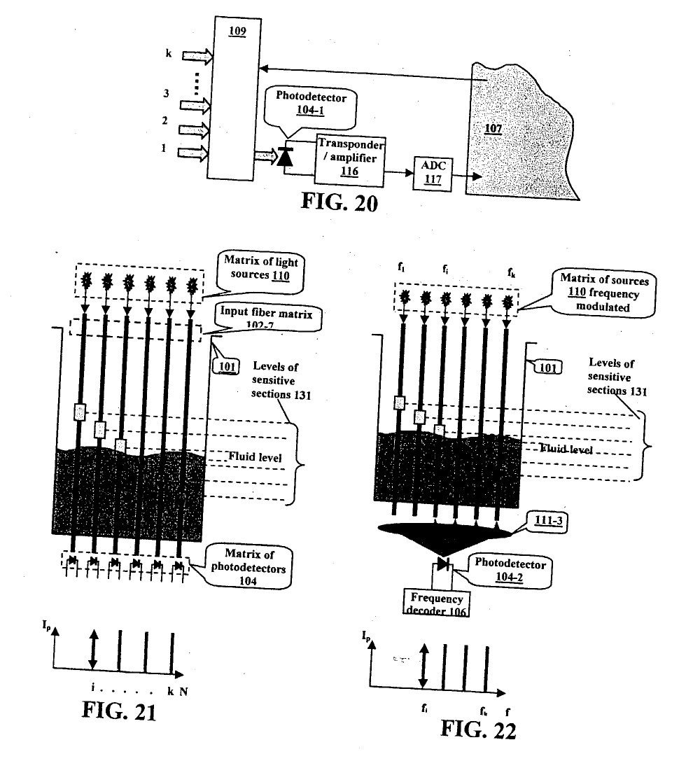

The schematics of multi-channel detection are shown in FIGS. 19-21. Separate light beams are detected by the light detectors assembled in the matrix 104; the electronic signals are converted or/and amplified with separate transponders/amplifiers and then the signals are directed to a multi-channel ADC 117′ as seen by FIG. 19a or they are commutated by an electronic commutator 119 and transmitted through the single transponder/amplifier 116 and ADC 117 to the processor 107. The multiple encoded beams can be collected also by the light collector (adder) 109 in one beam transmitted by the single fiber 103-1 to the light detector 104-1 as detailed by FIG. 20 and FIG. 1B. Another option is to focus the beams emerging from the output fiber matrix 103-2 on the detector 104-2 using an optical system 111-3 or to collect the beams in one beam with an optical collector (adder) 109 equipped either with the optical valves or optical scanning system as shown in FIG. 22. The optical sensing method with a set of sensitive sections 131 on the corresponding fibers that are located at different levels of the sensor housing implements either a multi-component detection system (matrix of light detectors) where each fiber transmits the light beam to a separate light detector as particularly detailed by FIG. 21 or a single-detector system 104-2 equipped with the light collecting device comprising the optical collector 109 or a focusing system 111-3 as detailed by FIG. 22. In the first case, each detector generates an electric signal characterized by detector (and output fiber) location in the matrix (channel number), and/or time delay of a given pulse in the given channel with respect to the beginning of pulse series for encoding in time domain, and/or frequency of modulation when frequency encoding of the light beams is applied, and/or spectral wavelength if spectral encoding is implemented as seen by the graph at the bottom of FIG. 21. In the case of single-detector system (FIGS. 22, 17 and 18) all the beams are detected simultaneously or one-by-one in series with a single detector, however the generated signals are characterized either by time delay of pulses that belongs to different channels if light encoding in time domain is implemented, or by frequency of modulation when encoding in frequency domain is applied as detailed by FIGS. 22 and 17, or by channel number and/or characteristic wavelength if a commutation system or a digital optical filter are used as specified by FIG. 18 and FIG. 20. The graphs in FIG. 21 and FIG. 22 illustrate operation of the sensor with the sensitive sections that transmit the light beams being immersed in fluid. and cut them or decrease their intensity being positioned in air above the fluid level; the signal from a channel with the sensitive sector currently matching the fluid level ondulates because of the level vibrations or waves.

Embodiments of the present invention can be designed to measure various ranges of fluid levels from less then a tenth of an inch to hundreds and thousands feet with the desired resolution that is limited virtually by the fiber diameter and wetting properties of the fluid and can be as small as 0.01″. Because. of digital nature of sensor response no optical noise in fibers or optical elements can influence accuracy of detection. It should be emphasized that the fiber optic sensor of the present invention is widely flexible and can be adapted to a large variety of liquids with different refractive indices, transparence, viscosity, turbidity, and other properties. The fibers and optical elements are manufactured presently from a variety of glass types with different refractive indices and many plastics are used also for fiber and optic production, so that there is enough room to select a material for the sensitive element and to match its index of refraction to that of the fluid. The sensor with the sensitive sections where the light beam is transmitted through the fluid can be applied to measure levels of relatively transparent liquids (μΔ1<<1, where μ is the liquid absorption factor and Δ1 is a distance of light propagation in liquid between the transmitting and receiving parts of the fibers). All other designs are effective equally either in transparent liquids or in highly absorbing and turbid liquids.

Since the sensor is relatively low cost and requires very little space in a tank it is possible to employ multiple sensors in a single tank to accurately measure fluid level when the tank is inclined, for example when vehicle is on a slope, surface vessel is in heavy seas, aircraft is maneuvering, etc. Moreover, the multiple sensors can be used to measure accurately the inclination as well as the fluid storage and the rate of fluid consumption (or leak) irrespective of inclination. Inclination-independent fiber sensor arrays are of great potential in application for airplane tanks, missile tanks with liquid propellant, torpedo storage tanks, etc. where they will provide both inflammation/fire safety and economy.

There are many possible applications of the fiber optic fluid sensor including fuel level sensing, in particular, aviation fuel in storage tanks and in aircrafts, diesel fuel in tracks, buses, off-road machinery, surface vessels and submarines, inflammable fluids like gasoline, hydrogen peroxide, etc., explosive liquids like nitroglycerin, process and aggressive chemicals (acids, alkali, etc.), medical reagents and high purity chemicals, cryogenic liquids including liquid oxygen, as well as numerous military applications.

In conclusion, it can be seen that the present invention provides universal approach to the design of optical fiber level sensors. The present invention significantly improves the reliability, accuracy and linearity of level detection and measurement, allows optical noise elimination to zero level owing to digital nature of the detection method, and achieves virtually the highest level of chemical compatibility while maintaining a relatively low production cost.

While the above is a complete description of specific embodiments of this invention, variety of modifications, constructions or equivalents can be implemented. Therefore, the above description should not be taken as limiting the scope of this invention as defined by the claims.

What is claimed is:

1. A fiber optic sensor for measuring level of fluids, comprising:
an ordered array of optical fibers, wherein each optical fiber has a single sensitive element located at a specific level with light transmittance depending on a position of said sensitive element either above or below the level of fluid;
an input light beam encoding system;
an output decoding system;
a housing to contain said array of said fibers.

2. The sensor of claim 1, wherein said array consists of the optical fibers without cladding or other means to isolate said fibers from said fluid which are disposed from the upper part of said housing and bended or terminated at a certain level which is specific for each said fiber.

3. The sensor of claim 2, wherein said fibers are bended to create the sensitive elements in the form of a U-sector or a loop on each fiber so that the rest part of each fiber is directed back to the top of said housing, each said U-sector or loop being shifted in vertical direction in relation to the neighboring ones to form a set of U-sectors or loops distributed along said housing.

4. The sensor of claim 3, wherein said U-sectors or loops are distributed equidistantly.

5. The sensor of claim 3, wherein said U-sectors or loops are distributed non-equidistantly.

6. The sensor of claim 3, wherein the lower sections of said U-sectors or loops are provided with a means to prevent light damping in said fiber if a drop of said fluid appears at the lower part of a U-sector or loop located in air.

7. The sensor of claim 2, wherein said fibers are terminated at a level specific for each fiber being connected to the reflective and/or luminescent members, so that a set of fibers of different length is disposed into said housing.

8. The sensor of claim 7, the difference in length between the consecutive fibers in said array being constant.

9. The sensor of claim 7, the difference in length between the consecutive fibers in said array being non-constant.

10. The sensor of claim 1, wherein said array consists of the fibers with cladding or other means to isolate them from said fluid, however with a section without cladding or isolation of the core, said non-isolated sections being shifted vertically for every consequent fiber to form a set of sensitive elements where said fluid can be in contact with said non-isolated sections of said fibers.

11. The sensor of claim 10, wherein said sections without. cladding or other isolation of said fibers are extended to the top of said housing; the transition points from isolated lower parts of said fibers to non-isolated upper parts are forming said sensitive elements.

12. The sensor of claim 10, wherein said fibers are disposed from the bottom of said housing and bended at a level specific for each fiber to form U-sector or loop so that said sensitive element is located on said U-sector or loop.

13. The sensor of claim 10, wherein said non-isolated sections are formed at the end of said fibers that are disposed in said housing to the different levels specific for each said fiber, the ends of said fibers being connected to the reflecting and/or luminescent member.

14. The sensor of claim 10, wherein said sensitive elements are distributed equidistantly.

15. The sensor of claim 10, wherein said sensitive elements are distributed non-equidistantly.

16. The sensor of claim 1, wherein the sensitive elements of said array of fibers are formed by the optical members placed inside a gap (rupture) between the parts of a fiber located at a level specific for each said fiber.

17. The sensor of claim 16, wherein said optical members are formed by the facets of said parts of said fiber in said gap.

18. The sensor of claim 17, wherein a focusing lens is formed by a convex facet of said fiber.

19. The sensor of claim 17, wherein a cone lens is formed by a conical facet of said fiber.

20. The sensor of claim 16, wherein said optical members focus and/or direct the light beam onto the facet of the receiving part of said fiber when said gap is in one medium and defocus and/or decline said light beam from the receiving fiber when said gap is transferred to another medium which refractive index is different from that of the first one.

21. The sensor of claim 20, wherein an optical member focusing the emerging light onto the facet of receiving part of said fiber is made of the material with refractive index lower then the refractive index of said fluid.

22. The sensor of claim 20, wherein said focusing member is a ball or half-ball microlens.

23. The sensor of claim 20, wherein said focusing lens is a cone lens.

24. The sensor of claim 19, a cone angle being small enough so that incident angle of any part of light beam to the cone generatrix exceeds the angle for total internal reflection if said cone lens is located in the medium with lower refractive index, however drops below the angle for total internal reflection if said cone lens is immersed in the medium with higher refractive index.

25. The sensor of claim 20, said optical member being a prism with an arbitrary prism angle.

26. The sensor of claim 25, said prism being made of material with refractive index smaller than refractive index of said liquid.

27. The sensor of claim 25, wherein a face of said prism is perpendicular to the light beam axis and the prism angle is sufficient to provide total internal reflection of incident light from another face of said prism when it is located in the medium with lower refractive index but it is not sufficient for total internal reflection when it is immersed in the medium with higher refractive index.

28. The sensor of claim 25, wherein a prism base is perpendicular to the light beam axis, the angle between the lateral faces is small enough to provide total internal reflection of the light beam from both lateral faces when said prism is located in the medium with lower refractive index, however it is not sufficient for total internal reflection when said prism is immersed in the medium with higher refractive index.

29. The sensor of claim 25, wherein the facet of said fiber is cut to form the lateral faces of said prism.

30. The sensor of claim 16, wherein an additional optical member is installed in said gap to redirect and/or concentrate the light onto the facet of the receiving fiber.

31. The sensor of claim 16, wherein said sensitive elements are distributed equidistantly.

32. The sensor of claim 16, wherein said sensitive elements are distributed non-equidistantly.

33. The sensor of claim 1, wherein the optical surfaces of said sensitive elements are covered with a layer (thickness d<<λ, where λ is the shortest characteristic wavelength emitted by the light source) of non-absorbing material which is non-wetted by said fluid.

34. The sensor of claim 1, wherein the lower sensitive elements of said array are spaced more frequently within pre-selected lower portion of said housing to provide more accurate measurements when the liquid in the tank is nearly exhausted.

35. The sensor of claim 5, said sensitive elements of said fibers being positioned with variable spacing along said holder to keep a relative accuracy of measurements constant with regard to the residual level of said fluid.

36. The sensor of claim 1, wherein the input end of said array of fibers is illuminated uniformly and simultaneously with a continuous or pulsed light source, the output ends of fibers being assembled in an ordered matrix and said decoding system picking up the distribution of light patterns emerging from said output matrix.

37. The sensor of claim 36, wherein said light source is a single light source common for all said fibers.

38. The sensor of claim 36, wherein said light source consists of the multiple light sources.

39. The sensor of claim 1, wherein the input ends of said array of fibers is assembled in an ordered matrix and illuminated by the light beam encoded with said encoding system, said decoding system providing decoding of the light signals emerging from the output of said array of fibers.

40. The sensor of claim 39, wherein said encoding system provides light coding in time domain.

41. The sensor of claim 40, wherein a series of consequently delayed light pulses are directed to said input matrix, so that a particular light pulse propagates only through the particular fiber of said array.

42. The sensor of claim 41, wherein said series of light pulses is generated by the multiple light sources turning on in series.

43. The sensor of claim 41, wherein the light beam is scanned over the fibers of said input matrix.

44. The sensor of claim 39, wherein said encoding system provides the light coding in frequency domain.

45. The sensor of claim 44, wherein said encoding system modulates light intensity so that the frequency of modulation is specific for a particular fiber of said input matrix.

46. The sensor of claim 39, wherein said encoding system provides the light coding in wavelength domain (spectral coding), so that the beam with specific wavelength is directed into the specific fiber of said input matrix.

47. The sensor of claim 39, wherein a light collector (optical summer) is installed at the output of said array of fibers to form a single light beam bearing the coding features of all particular beams and being transmitted to said decoding system by a single output fiber.

48. The sensor of claim 40, the mentioned methods of light beam encoding being used simultaneously or in any combination of them.

49. The sensor of claim 39, wherein the multiple continuous or pulsed light sources are used.

50. The sensor of claim 39, wherein a single continuous or pulsed light source is used.

51. The sensor of claim 16, wherein said input and output ends of said array of fibers are the same and a beam splitter provides separation of the input and output light beams.

52. The sensor of claim 51, wherein the reflective elements are installed at the ends of said fibers which are opposite to the input/output ends.

53. The sensor of claim 51, wherein the luminescent elements are installed at the ends of said fibers opposite to the input/output ends.

54. The sensor of claim 1, wherein a single light detector is used to pick up output light signals.

55. The sensor of claim 1, wherein the multiple light detectors are used to pick up the output light signals.

56. The sensor of claim 54, the circuits of said decoding system being continuously connected to the light detectors.

57. The sensor of claim 55, the light detectors being scanned by said decoding system one after another.

58. The sensor of claim 55, wherein CCD or CMOS are used to detect the light patterns.

59. The sensor of claim 58, wherein said decoding system operates with one frame of data.

60. The sensor of claim 58, wherein said decoding system operates with more than one frame of data.

61. The sensor of claim 58, wherein said decoding system having random access to the pixels of the detector.

62. The sensor of claim 1, wherein said housing comprises a protecting jacket with the openings at the top and bottom sections of said jacket; said fluid penetrates in or pouring out of said jacket through the lower openings and air flowing through the upper openings.

63. The sensor of claim 62 wherein the cross-section of said lower openings provides the reliable level measurements but damps simultaneously the higher frequency oscillations (waves, vibrations, shocks) of fluid level.

64. The sensor of claim 63, wherein a protective mesh is installed on said openings.
